(19) United States
(12) Patent Application Publication
(10) Pub. No.: US 2017/0158383 A1
(43) Pub. Date: Jun. 8, 2017

(54) TAMPER-EVIDENT ENCLOSURE

(71) Applicant: Tessyn Plastics Corporation, Elbridge, NY (US)

(72) Inventor: David Young, Syracuse, NY (US)

(73) Assignee: Tessyn Plastics Corporation, Elbridge, NY (US)

(21) Appl. No.: 15/371,556

(22) Filed: Dec. 7, 2016

Related U.S. Application Data
(60) Provisional application No. 62/264,376, filed on Dec. 8, 2015.

(51) Int. Cl. B65D 41/34; B65D 50/00; B29C 65/04; B65D 1/02; B29C 69/00; A61J 1/03; B65D 21/02

(52) U.S. Cl. CPC B65D 41/3495; A61J 1/03; B65D 50/00; B65D 21/0233; B65D 1/0253; B29C 69/00; B29C 65/04; B29C 45/00

(57) ABSTRACT

An exemplary enclosure including a resin injection-molded canister defining a top end, a bottom end and an intermediate body disposed therebetween. The enclosure, furthermore, includes a resin injection-molded fitment defining a base, a tamper-evident panel, and a neck disposed therebetween. The top end includes a rim having an inwardly facing mating surface and the base includes a rim having an outwardly facing mating surface. The canister and fitment are configured to be fused along the inwardly and outwardly facing mating surfaces subsequent to being filled with the consumer product. The tamper-evident panel is molded into the fitment during the injection molding process while the mating plane of the fitment and canister is located below the base of the fitment to optimize the opening of the canister for being filled with the consumer product.

### CROSS-REFERENCE TO RELATED APPLICATIONS

This application is a non-provisional of, and claims the benefit and priority of, U.S. Provisional Patent Application No. 62/264,376, filed on Dec. 8, 2015. The entire contents of such application are hereby incorporated by reference.

### BACKGROUND OF THE INVENTION

The subject matter disclosed herein relates to containers for medicine, which requires a sealed compartment and at least one tamper-evident indicator.

There are a variety of containers for storing medications (e.g., pills, tablets, capsules, etc.) which require a seal to reduce contamination and have tamper-evident indicators to make unauthorized access easily detected. The seal and tamper-evident indicator are typically additional components which are incorporated into the container during the assembly process.

Current containers are created by a blow molding process used in the production of hollow plastic enclosures. A blow-pin is inserted into the mold to inflate plastic material against a cavity wall such that the material takes the shape of the cavity. Inasmuch as the plastic material is blown against a mold cavity/surface, blow molding produces a highly accurate Outer Mold Line (OML). On the other hand, since the inner surface is not controlled by, or blown against, a mold surface, a far less accurate Inner Mold Line (IML) is produced. That is, since the material must stretch due to the complexity of the mold when the object is blown, it is difficult to control the accuracy of the thickness and the accuracy of the IML. Once the container is molded, the container is subsequently filled and sealed using a variety of techniques.

While blow molding produces a light-weight, thin-walled structure, such enclosures/containers are often ill-suited for stacking and shipping prior to being filled with the consumer product. That is, since such enclosures/containers require a closed-end fill port, i.e., the end which allows the blow-molded polymer to be blown against the mold cavity, they do not typically produce a configuration with facilitates stacking. Consequently, such enclosures/containers must be shipped without the benefit of nesting one container within another. As such, the cost of shipping such enclosures from the blow-molding facility to the packaging facility is dramatically increased. To reduce the cost of shipping, manufacturers have been faced with the unfavorable prospect of building/buying a packaging facility within a short distance of the blow molding facility. It will be appreciated that the cost of building/buying a packing facility may not be best interest of the enclosure/container manufacturer or visa-versa.

A need, therefore, exists for an enclosure which produces an accurate surface along the Inner and Outer Mold Lines (i.e., along the IML and OML of the enclosure), is sufficiently robust for everyday use, and is volumetrically efficient to facilitate shipping and handling.

### BRIEF DESCRIPTION OF THE INVENTION

An exemplary enclosure is provided including a resin injection-molded canister defining a top end, a bottom end and an intermediate body disposed therebetween. The enclosure, furthermore, includes a resin injection-molded fitment defining a base, a tamper-evident panel, and a neck disposed therebetween. The top end includes a rim having an inwardly facing mating surface while the base includes a rim having an outwardly facing mating surface. The canister and fitment are configured to be fused along the inwardly and outwardly facing mating surfaces subsequent to being filled with the consumer product. The tamper-evident panel is molded into the fitment during the injection molding process while the mating plane of the fitment and canister is located below the base of the fitment to optimize the opening of the canister for being filled with the consumer product.

In one embodiment, the intermediate body of the canister defines an outwardly directed draft angle (α) such that the canister may be stackable to facilitate shipment and transport.

In another embodiment, a method is provided for fabricating a tamper-evident enclosure facilitating packaging and shipment, comprising the steps of: injection molding a canister having a top end, a bottom end and an intermediate body disposed therebetween, injection molding a fitment having a tamper-evident panel, a base and a neck disposed therebetween; and fusing the injection molded canister and fitment along the mating surface to seal the contents within the tamper-evident enclosure. The top end of the canister and base of the fitment each have a mating surface which is fused to seal the contents of the tamper-evident enclosure subsequent to being filled.

This brief description of the invention is intended only to provide a brief overview of the subject matter disclosed herein according to one or more illustrative embodiment, and does not serve as a guide to define or limit the scope of the invention. This brief description is provided to introduce an illustrative selection of concepts in a simplified form that are further described below in the detailed description. This brief description is not intended to identify key features or essential features of the invention, nor is it intended to be used as an aid in determining the scope of the invention.

### BRIEF DESCRIPTION OF THE DRAWINGS

So that the manner in which the features of the invention may be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference may be made to the following detailed description, read in connection with the drawings in which:

FIG. 1 is a profile view of a tamper-evident enclosure including a canister, a threaded cap, and a fitment disposed beneath the threaded cap in accordance with an exemplary embodiment;

FIG. 2 is a perspective view of the tamper-evident enclosure with the cap removed to reveal a pull ring of the tamper evidence feature of the enclosure;

FIG. 3 is a perspective view of the tamper-evident enclosure with both the cap and the tamper evidence feature removed to enable access to the internal contents of the enclosure;

FIG. 4 is an isolated plan view of the fitment of the tamper-evident enclosure revealing an outwardly facing mating surface of the base;

FIG. 5 is a sectional view through the pull ring of the tamper evidence illustrating the sectional details of the base of the fitment;

FIG. 6 is an isolated side view of the canister revealing a draft angle of the intermediate body thereof;

FIG. 7 is a sectional view through the canister depicting the inwardly facing mating surface of the canister rim;

FIG. 8 depicts a perspective view of a stack of tamper-evident canisters prepared for transport and shipment;

FIG. 9 is an enlarged, broken away, sectional view of an edge of the tamper-evident enclosure shown in FIG. 1.

### DETAILED DESCRIPTION OF THE INVENTION

Various exemplary embodiments serve to create a tamper-evident enclosure where the threads associated with the cap, the child resistant lock and the tamper-evident seal are integrally molded together within a single fitment. As a non-limiting example, each of the components are created having a unitary design and the components are joined together to create a tamper-evident enclosure assembly.

The present disclosure is generally related to a tamper-evident enclosure configured to facilitate shipping, economize material/parts, simplify manufacture, and maintain structural rigidity.

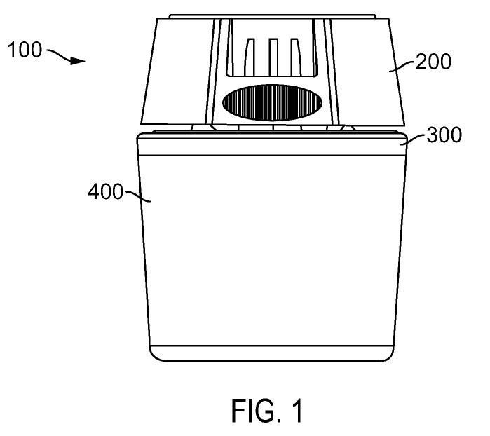

FIG. 1 illustrates an enclosure assembly comprising a cap 200, a fitment 300, and a canister 400 forming a tamper-evident enclosure assembly 100 in accordance with an exemplary embodiment. The cap 200 is attached to the fitment 300 to engage a child resistant lock. The child resistant lock may be a screw, flip-top, pressure, or additional types of child resistant locks which comply with the relevant standards (e.g., International Organization for Standards (ISO), ASTM International (ASTM), or other standards for child resistant locks).

The fitment 300 is sealed to the canister 400 and, in the exemplary embodiment, the fitment 300 is induction welded to the canister 400 to effect a water-tight seal therebetween. In induction welding, a high frequency electromagnetic field acts on an electrically conductive material or a ferromagnetic component. One or both of the components, i.e., the fitment 300 and/or the canister 400, are heated to join and seal the parts together. In one embodiment, either or both of the fitment 300 and/or the canister 400 are implanted with metallic, or ferromagnetic compounds (called susceptors) in strategic locations to weld one another together. In additional embodiments, a third component which is electrically conductive or ferromagnetic is placed between the mating surfaces of the fitment 300 and the canister 400 to join them together. The type of sealed/welded/fused interface between the fitment 300 and the canister 400 may be, but not limited to, a moisture, hermetic, or other type of interface known in the art.

In one embodiment, the cap 200, the fitment 300, and the canister 400 are made of a plastic material such as, but not limited to, polyolefin, styrene, polypropylene, copolymer polypropylene, polystyrene, thermoplastic elastomers, thermoplastic elastomers, or other forms thereof known in the art. In additional embodiments, the cap 200, the fitment 300, and the canister 400 are made of a flexible non-woven or woven material, such as but not limited to melt-blown, co-form, air-laid, bonded-carded web materials, hydro-entangled materials, and other forms thereof known in the art. In further additional embodiments, the cap 200, the fitment 300, and the canister 400 are made from a plastic flexible film material, such as, but not limited to, polyethylene, polypropylene, polystyrene, copolymer polypropylene, or other forms thereof known in the art. The cap 200, fitment 300, and canister 400 may be made of the same different materials depending upon the strength and stiffness sought in the finished product.

In the exemplary embodiment, the cap 200, fitment 300, and tamper-evident canister 400 each employ a unitary construction. The cap 200, the fitment 300, and the canister 400 are each molded as a single element through resin injection molding capable of producing highly accurate dimensions along both the inner and outer mold lines of the injection molded components

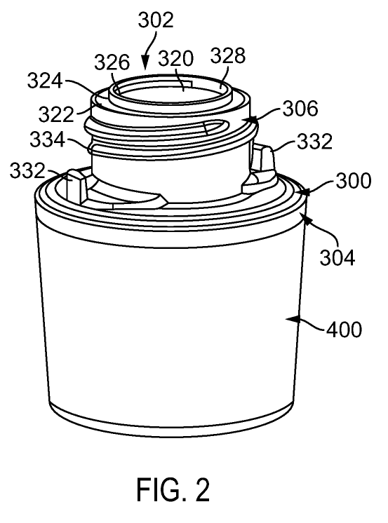

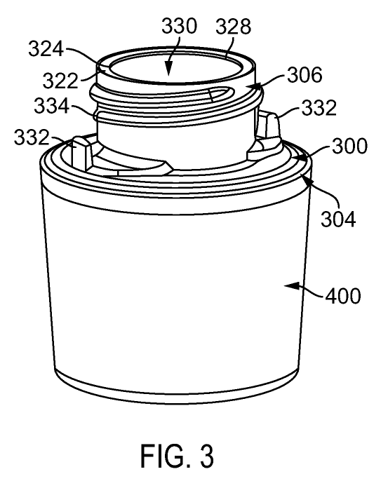

FIG. 2 illustrates the enclosure assembly 100 with the cap 200 removed in accordance with an exemplary embodiment to reveal the external features of the fitment. In the exemplary embodiment, the fitment 300 comprises a tamper-evident panel 302, an annular base 304 and a cylindrical neck 306 disposed therebetween. The tamper-evident panel 302 comprises a central panel 320, an annular ring 322 disposed about, and generally co-planar with, the central panel 320, a circular score line 324 interposing the annular ring 322 and the central membrane or panel 320, and a pull ring 326 connecting to an arcuate pull-tab or partition 328 projecting upwardly from an edge of the central panel 320. Generally, the tamper-evident panel is removed to access to the contents of the canister 400 (as shown in FIG. 3). In the described embodiment, the circular score line 324 generally comprises a circular region of thin plastic which may be torn by the arcuate pull-tab or partition 328 to separate the central panel 320 form the annular ring 322.

FIG. 3 illustrates the enclosure assembly 100 with the tamper-evident panel 302 removed such that an opening 330 is created to allow access to the internal contents of the canister 400. In the exemplary embodiment, the annular ring 322 remains intact, or attached to the upper edge of the neck 304 following removal of the central panel 320. In other embodiments, more or less of the annular ring 322 remains depending upon the desired size of the opening 330, or the contents which are to be removed from the enclosure. For example, the opening can be small if pills are to be contained and dispensed from the enclosure once the tamper-evident panel 302 is removed.

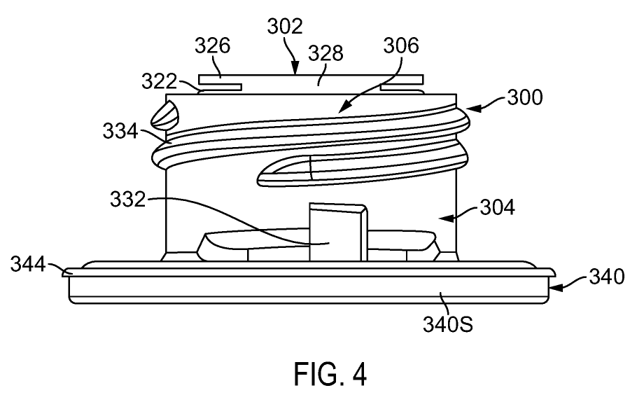

In FIGS. 3 and 4, the cylindrical neck 306 of the fitment 300 projects upwardly from the base 304 and may include a spiral thread 334 disposed about the peripheral outer surface of the neck 306. The spiral thread 334 is configured to engage a spiral groove or lip (not shown) formed along an internal wall of the cap 200. Depending upon the type of cap employed, e.g., threaded, snap-on, plugged, etc., the neck and base need not be cylindrical but may have a variety of shapes including, but not limited to, a triangular, quadrilateral, elliptical, polygonal, square etc., provided that the fitment 300 may be sealed, as discussed below, to the canister 400.

The central panel 320 may have a uniform or variable thickness. Similarly, the circular score line 324 or region of reduced thickness, i.e., relative to the central panel 320 and the annular ring 322, may also vary in thickness around the circle. The thickness thereof functions to modify force required to remove the central panel 320 from the adjacent annular ring 322. The arcuate pull-tab or partition 328 may span an arc of between about one-hundred and eighty degrees (180°) to as little as about five degrees (5°) depending upon the thickness of the pull-tab or partition 328.

The neck 306 of the fitment has a predetermined thickness, which may be either uniform or variable throughout the neck 306. In the exemplary embodiment, the intersection between the neck 306 and the base 304 defines a small radius. Alternatively, the intersection therebetween may be chamfered. The base 304 supports or integrates one or more child protection locks 336 between the neck 306 and the outer radius of the base 304. In the described embodiment, two (2), child protection locks 336 project upwardly from the base 304 and are disposed one-hundred and eighty degrees (180°) apart on each side of the neck 306.

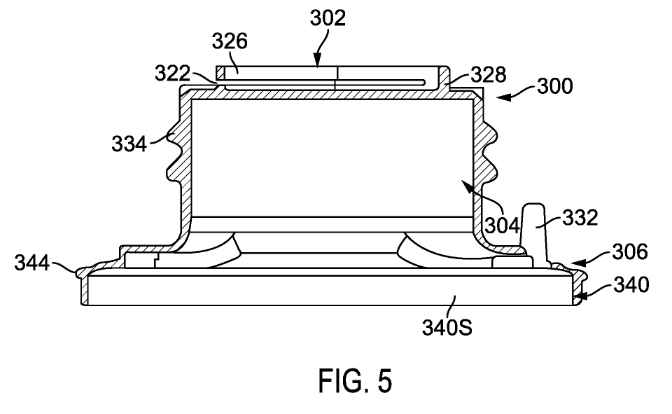

In FIGS. 4 and 5, base 304 of the fitment 300 comprises a rim or collar 340 defining an outwardly facing mating surface 340S. The rim or collar 340 is integral with and projects downwardly from the base 304 of the fitment 300 and may comprise a tapered, concave, convex or substantially linear shape. As mentioned above, when viewed in three-dimensions, the rim or collar 340 may be cylindrical or polygonal, i.e., form a triangular, square, rectangular, or hexagonal shape, etc. The thickness of the rim or collar 340 is sufficient to support, load or suspend electrically conductive or ferromagnetic material. Such materials are incorporated to induction weld, melt or fuse the outwardly and inwardly facing mating surfaces 340S, 440S of the fitment 300 and canister 400, respectively, of the tamper-evident enclosure 100. This manufacturing step is discussed in greater detail below when discussing the fabrication of the enclosure 100.

In the exemplary embodiment, the base 304 may include a radial lip or flange 344 extending outwardly from, or beyond, the rim or collar 340 of the fitment 300. The radial lip 344 may extend outwardly a radial distance corresponding to the thickness of the canister 400 or, alternatively, a radial distance corresponding to a rim 440 of the canister 400, i.e., disposed along a top end 402 thereof. As such, the radial lip 344 limits the depth that the rim 340 may be inserted into the canister 400 and is flush with an exterior surface of the rim 440, i.e., the exterior surface 410 of the canister. Furthermore, the lip 344 may function to align the radially outer mating surface 340S of the fitment rim 340 from the radially inner mating surface 440S of the canister rim 440.

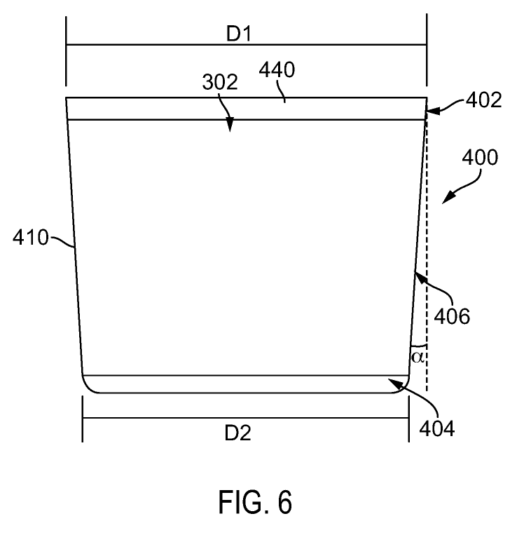

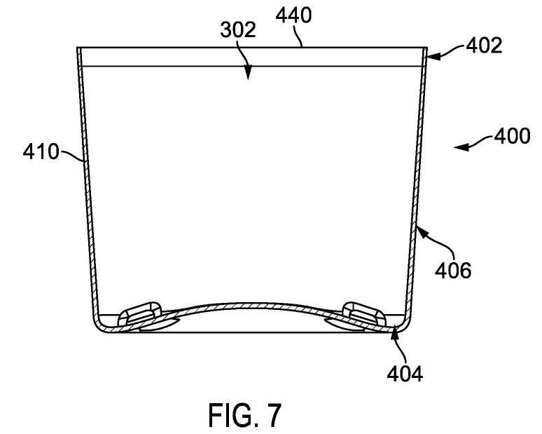

In FIGS. 6 and 7, the canister 400 includes a top end 402, a bottom end 404 and an intermediate body 406 disposed therebetween. The inwardly facing mating surface 440S is defined by the rim 440 of the canister 400. Furthermore, the top end 402 defines a first diameter D1 which is larger than a second diameter D2 defined by the bottom end 404 of the canister 400. In one embodiment, the exterior surface 408S of the intermediate body 406 defines an draft angle (α) which is, at minimum, greater than about six degrees (6°). In another embodiment, the draft angle (α) is less than about twenty degrees (20°).

The fitment 300 and canister 400 are formed by an injection molding process wherein a mold defines the inner and outer mold lines IML and OML of each component of the enclosure assembly 100. Resin is injected under heat and pressure into the mold cavity (not shown) via injection ports until resin flows out of one or more exit sprues (not shown). In the described embodiment, a polymer is fed into a heated barrel, mixed, and forced into the mold cavity, where it cools and hardens to the configuration of the cavity. As such, both the inner and outer mold line (IML and OML) details of the fitment 300 and canister 400 are accurately formed/represented following removal from the thermoplastic fabrication tool.

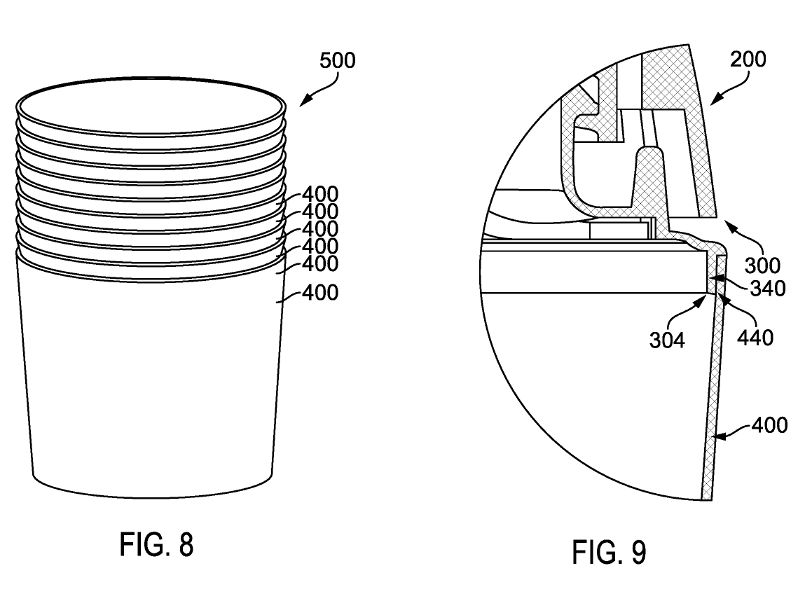

More specifically, in FIGS. 7 and 8, the injection molding process may fabricate the enclosure assembly 100 such that one or more draft angles α are defined along the inner surface 410S of the intermediate body 406 by the inner and outer mold surfaces. For example, the inner surface 410S may define a first draft angle α facilitating stacking of the canisters 400 while a second draft angle may prevent the rim 440 of an adjacent canister 400 from frictionally engaging, i.e., hanging-up on, the outer edge of an adjacent, nested canister 100.

FIG. 8 depicts a perspective view of a nested stack 500 of canisters 400 which have been prepared for transport and shipment. It will be appreciated how this configuration greatly improves shipping efficiency by reducing the amount of “air” shipped along the highways along with the fuel required for transport.

Upon reaching the “fill” facility, the canisters are separated and filled with the consumer product. Thereafter, the rim 340 of the fitment 300, which includes a tamper-evident panel 302, is joined/inserted into the rim 440 of the canister 400. The outwardly facing mating surface 340S of the rim 340 is disposed in opposed relation to the inwardly facing mating surface 440S of the canister rim 440. When the rim 340 of the fitment 300 engages the rim 440 of the canister 400, the material loaded within at least one of the rims 340, 440 is excited to weld or fuse the mating surfaces 340S, 440S together. In the described embodiment, the mating surfaces 340S, 440S may be fused by induction welding, or melted by radio frequency (RF) excitation of a ferromagnetic material loaded within one of the rims 340, 440. In each process, the temperature of the thermoplastic material in the fitment 300 and canister 400 is raised to the glassine temperature of the material, causing the plastic material to flow, fuse and seal together. Consequently, induction welding and/or microwave excitation seals the enclosure 100 along a plane which is below the neck 306 of the fitment 300.

Advantages of this construction and fabrication process includes the creation of several components in an expeditious, tolerance-controlled, and economical process. The enclosures are stackable to increase the volume of the containers which may be shipped. The injection molding process produces a more accurate enclosure than can be fabricated by a blow molding process. Furthermore, the amount of material is regulated which reduces the amount of waste material. Finally, the use of induction molding/ferromagnetic welding to join the fitment with the canister facilitates automation.

Various embodiments in accordance with the invention have been described in detail with particular reference to certain preferred aspects thereof, but it will be understood that variations, combinations, and modifications may be effected by a person of ordinary skill in the art within the spirit and scope of the invention.

### PARTS LIST

100 enclosure assembly
200 cap
300 fitment
400 canister
302 tamper-evident panel
304 annular base
306 neck
320 central panel
322 annular ring
324 score line
326 pull ring
328 partition
330 opening
332 plurality of locking elements
334 spiral thread
340 rim of fitment
340S outwardly facing mating surface
344 radial lip
400 canister
402 top end
404 bottom end
406 intermediate body
408 interior surface
440 rim of top end
410 exterior surface
440S inwardly facing mating surface
D1 first diameter
D2 second diameter

What is claimed is:

1. A tamper-evident enclosure for packaging a consumer product, comprising:
a canister defining a top end, a bottom end and an intermediate body disposed therebetween, the top end defining a rim having an inwardly facing mating surface and the intermediate body defining an outwardly directed draft angle (α); and
a fitment defining a base, a tamper-evident panel, and a neck disposed therebetween, the base having a rim defining an outwardly facing mating surface;
each of the canister and the fitment being fabricated by a resin injection molding process and configured for being sealed along the inwardly and outwardly facing mating surfaces subsequent to being filled with the consumer product.

2. The tamper-evident enclosure of claim 1 wherein at least one rim of the canister and the fitment are loaded with an electrically conductive material to induction weld the canister and fitment together.

3. The tamper-evident enclosure of claim 1 wherein at least one rim of the canister and the fitment are loaded with a ferromagnetic material which is excited by electromagnetic energy to weld the canister and fitment together.

4. The tamper-evident enclosure of claim 1 wherein the draft angle (α) is greater than about six degrees (6°).

5. The tamper-evident enclosure of claim 4 wherein the draft angle (α) less than about twenty degrees (20°).

6. The tamper-evident enclosure of claim 1 wherein the tamper-evident panel is integrally molded with the neck and with a score line inboard of the neck, and further comprises a circular pull ring and pull tab integrally molded with the panel to facilitate removal of the tamper-evident panel.

7. The tamper-evident enclosure of claim 1 wherein the rim of the canister defines a first diameter dimension and the bottom end of the canister defines a second diameter dimension, and wherein the first diameter dimension is greater than the second diameter dimension.

8. A tamper-evident enclosure for packaging a consumer product, comprising:
a resin injection molded canister defining a top end, a bottom end and an intermediate body disposed therebetween, the top end including a rim having an inwardly facing mating surface; and
a resin injection molded fitment defining a base, a tamper-evident panel, and a neck disposed therebetween, the base including a rim having an outwardly facing mating surface;
the canister and the fitment configured for being fused along the inwardly and outwardly facing mating surfaces subsequent to being filled with the consumer product.

9. The tamper-evident enclosure of claim 8 wherein the intermediate body defines an outwardly directed draft angle (α) to facilitate stacking during shipment.

10. The tamper-evident enclosure of claim 9 wherein the draft angle (α) is greater than about six degrees (6°).

11. The tamper-evident enclosure of claim 10 wherein the draft angle (α) less than about twenty degrees (20°).

12. The tamper-evident enclosure of claim 8 wherein at least one rim of the canister and the fitment are loaded with an electrically conductive material to induction weld the canister and fitment together.

13. The tamper-evident enclosure of claim 8 wherein at least one rim of the canister and the fitment are loaded with a ferromagnetic material which is excited by electromagnetic energy to weld the canister and fitment together.

14. The tamper-evident enclosure of claim 8 wherein the tamper-evident panel is integrally molded with the neck and with a score line inboard of the neck, and further comprises a circular pull tab integrally molded with the panel to facilitate removal of the tamper-evident panel.

15. The tamper-evident enclosure of claim 8 wherein the rim of the canister defines a first diameter dimension and the bottom end of the canister defines a second diameter dimension, and wherein the first diameter dimension is greater than the second diameter dimension.

16. A method for fabricating a tamper-evident enclosure facilitating packaging and shipment, comprising the steps of:
injection molding a canister having a top end, a bottom end and an intermediate body disposed therebetween, the top end having a mating surface;
injection molding a fitment having a tamper-evident panel, a base and a neck disposed therebetween, the base having a mating surface; and
fusing the injection molded canister and fitment along the mating surface to seal the contents within the tamper-evident enclosure.

17. The method according to claim 16 wherein the step of fusing the injection molded canister and fitment further comprises the steps of:
loading at least one rim of the fitment and the canister with a ferromagnetic material and
exiting the ferromagnetic material with radio frequency energy to fuse the surrounding resin injected thermoplastic together.

18. The method according to claim 16 wherein the step of fusing the injection molded canister and fitment further comprises the steps of:
suspending a conductive material within at least one rim of the fitment and the canister; and
passing a current through the conductive material to melt the surrounding resin injected thermoplastic together.

19. The method according to claim 16 wherein the step of fusing the injection molded canister and fitment further comprises the steps of:
molding a rim along the top end of the canister such that the diameter thereof is larger than the diameter of the bottom end to produce a draft angle α sufficient to facilitate nesting of the canister during shipment.

20. The method according to claim 19 wherein the step of molding a rim along the top end of the canister further comprises the step of:
producing a draft angle α greater than at least six degrees (6°).
